(19) United States
(12) Patent Application Publication
(10) Pub. No.: US 2025/0374394 A1
(43) Pub. Date: Dec. 4, 2025

(54) Headlamp with Improved User Interface for Battery Life Management

(71) Applicant: Zedel, Crolles (FR)

(72) Inventor: Nicolas Beaurent, La Pierre (FR)

(21) Appl. No.: 19/222,089

(22) Filed: May 29, 2025

(30) Foreign Application Priority Data
May 29, 2024 (EP) 24315251.9
Apr. 25, 2025 (EP) 25172594.1

(51) Int. Cl. H05B 45/10; F21V 23/04; H05B 47/11; H05B 47/16; H05B 47/19

(52) U.S. Cl. CPC H05B 45/10; F21V 23/0464; F21V 23/0492; H05B 47/11; H05B 47/16; H05B 47/19

(57) ABSTRACT

A headlamp (700) is disclosed, including a light source, a push button (710) for controlling the lamp, a power module for generating a current supply for said light source, an M-segment display (720) for displaying the battery charge status, a control module for adjusting the light intensity generated by said light source, and an accelerometer configured to provide, at regular intervals, data representing an acceleration of the headlamp along at least one horizontal axis X1 and one vertical axis Y1. The control module is configured to store and digitally process the data representative of said acceleration. Characterized in that the control module is further configured to perform digital processing of said captured accelerometer data.

### RELATED PATENT APPLICATION

This application is related to US patent application Ser. No. ______ filed on ______ (docket no. ZE25-001), which is incorporated by reference herein in its entirety, and assigned to a common assignee.

### TECHNICAL FIELD

The present invention relates to the field of headlamps equipped with a system for managing the battery life of the lamp, and in particular to a headlamp comprising an improved user interface for this management.

### BACKGROUND ART

The applicant of the present patent application destined several headlamps comprising battery life management systems. One particular headlamp has been designed with a so-called reactive or dynamic lighting, the operating principle of which is illustrated in FIG. 1. This headlamp comprises an electronic circuit equipped with a sensor that analyzes the brightness outside to instantly deliver the adjusted lighting power and optimal beam shape for the situation.

This type of headlamp has proven to be particularly suitable for sport activities and particularly intensive sports because it relieves the user of the manual mode adjustments that would be necessary to switch between different beam power thresholds. In particular, it allows a user to keep their hands free and their mind fully focused on their activity, regardless of the lighting situation.

In proximity lighting, for example, the user can observe or examine an object at close range (reading a map, making a rope knot or pitching a tent, for example) and the lamp can produce a very wide and low-power light beam, automatically set to a minimum threshold value thanks to this dynamic lighting technique. The lighting automatically adapts to the distance of the object.

On the contrary, in a situation of movement, for example when the user engages in walking and/or running, the beam becomes mixed: wide at the level of the feet and focused to see at a few meters and anticipate the ground relief. In addition, when in a situation of distant vision, the user raises his head to see far away—for example to look for a beacon during a run or even a relay attached to a climbing wall, the power of lighting increases dramatically and the beam becomes focused to best assist the lamp user.

### SUMMARY OF THE INVENTION

Note that the reactive or dynamic lighting technology (Reactive Lighting) has proved to be particularly economical in use and makes it possible to advantageously increase the autonomy of the batteries since its implementation, under the control of a calculator, aims to optimize battery consumption, offering greater autonomy for the lamp.

European patent application EP21164886.0 filed on 25 Mar. 2021 by the Applicant of the present application and published under reference EP4064792 (internal reference 313ep-ZED22ep) describes a further improvement to this reactive lighting technique through the integration of an accelerometer, which allows the determination, through statistical analysis of accelerometry data, of a detailed activity profile allowing optimal configuration of the dynamic lighting technique based on an automatically identified profile.

The advent of such headlamps requires the development of more efficient, more ergonomic battery management that matches the practicality of such lamps. This is the problem to be solved by the present invention.

The purpose of the present invention is to propose a battery life management system that takes advantage of the possibilities offered by an accelerometer in the headlamp.

Another aim of the present invention is to provide a new and economic user interface which provides simple and effective management of the battery life of a headlamp.

Another aim of the present invention is to provide a headlamp equipped with an accelerometer that is configured to provide an efficient user interface for programming the autonomy of the battery.

The invention achieves these goals by means of a lamp, such as a headlamp including a battery, comprising:
a light source;
a push button for controlling the lamp;
a power module for generating a current supply for the light source;
an M-segment display for displaying the battery charge status;
a control module for adjusting the light intensity generated by said light source; and
an accelerometer configured to provide, at regular intervals, data representative of an acceleration of the headlamp along at least one horizontal axis X1 and one vertical axis Y1.

The control module is configured to store and digitally process the data representative of said acceleration and to perform digital processing of said captured accelerometer data in order to detect a set of N>2 consecutive taps and, following said detection, to enter a battery life programming mode. In this programming mode, the control module performs a circular scrolling of the display of said LED segments each time the user presses the push button, each of said LED segments corresponding to a programming of one unit of autonomy, for example, one hour.

Preferably, the programming mode is exited after a predetermined duration.

In a particular embodiment, M=5 and N=4, and the unit of autonomy is one hour.

In a particular embodiment, the control module is further configured to perform digital processing of said accelerometer data captured along at least one horizontal axis to detect a double tap and, following this detection, to control a temporary increase in the brightness of the headlamp.

In a particular embodiment, the headlamp comprises a light sensor for capturing light from the wearer's environment, and the control module is configured to control the brightness of the light source based on the information generated by the light sensor.

The invention also allows the implementation of a method for controlling a headlamp comprising the steps of:
generating, by means of an accelerometer, accelerometric data along one or more axes μx, μy and μz;
storing said accelerometric data in a storage memory;
processing the accelerometric data so as to detect a set of N>2 consecutive taps on the lamp;
in the event of detection of said sequence of four taps, entering a mode for programming a battery life of said lamp;
displaying the current value of the programming of said battery life on an M-segment display, each segment displayed corresponding to a unit of battery life; and
starting a predetermined time delay;
detecting one or more presses on said headlamp push button and, in response to said detection, modify the display of said display to add a time unit to the current programming for each press and, when the current value is already the maximum value, to return to a minimum value of a battery life programming corresponding to one time unit;
testing the end of the time delay; and
exiting the programming mode and apply the new current value of the newly programmed battery life.

Preferably, M=5 and N=4, and the battery life is set to 1 hour.

### BRIEF DESCRIPTION OF THE DRAWINGS

Other characteristics, object and advantages of the invention will appear on reading the description and the drawings below, given solely by way of non-limiting examples, in the attached drawings:

FIG. 1 illustrates the block diagram of dynamic or reactive lighting known in the art.

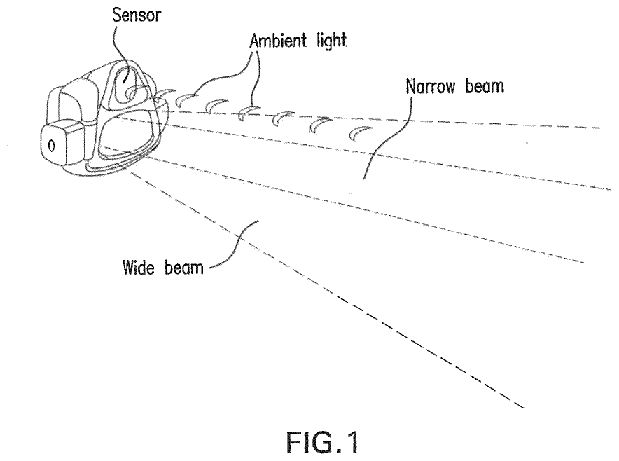

FIG. 2 represents a general architecture of a headlamp incorporating a light sensor and an accelerometric sensor, and suitable for implementing the method steps of one embodiment of the present invention.

FIG. 3 illustrates a first implementation method enabling a temporary brightness increase command.

FIG. 4 illustrates a particular embodiment of a general architecture for processing accelerometric data in order to extract a reference accelerometric vector that can be associated with a control code.

FIG. 5 illustrates a learning process for a headlamp based on an analysis of the accelerometric data extracted from the accelerometric sensor, for the purpose of recording a control instruction related to a predetermined tap jointly defined by one or more of the user's fingers.

FIG. 6 illustrates a method for controlling a headlamp based on an analysis of accelerometer data extracted from the accelerometric sensor, with a view to extracting a control instruction and its automatic execution.

FIG. 7 illustrates a perspective view of a headlamp comprising a life duration management process according to one embodiment of the invention.

FIG. 8 illustrates a process for managing the battery life according to one embodiment of the invention.

### DETAILED DESCRIPTION

It is now described how one may program an autonomy of a headlamp without requiring complex and costly components, by means of a simple but very effective user interface taking profit of the presence of an accelerometer sensor generating acceleration signals, as known in the headlamp described in European patent application EP21164886.0, the content of which is incorporated into this application by simple reference.

Such user interface can clearly be used advantageously in a headlamp with “dynamic lighting” will be seen in the embodiment described, but in any headlamp whatsoever.

### I. General Architecture of One Embodiment

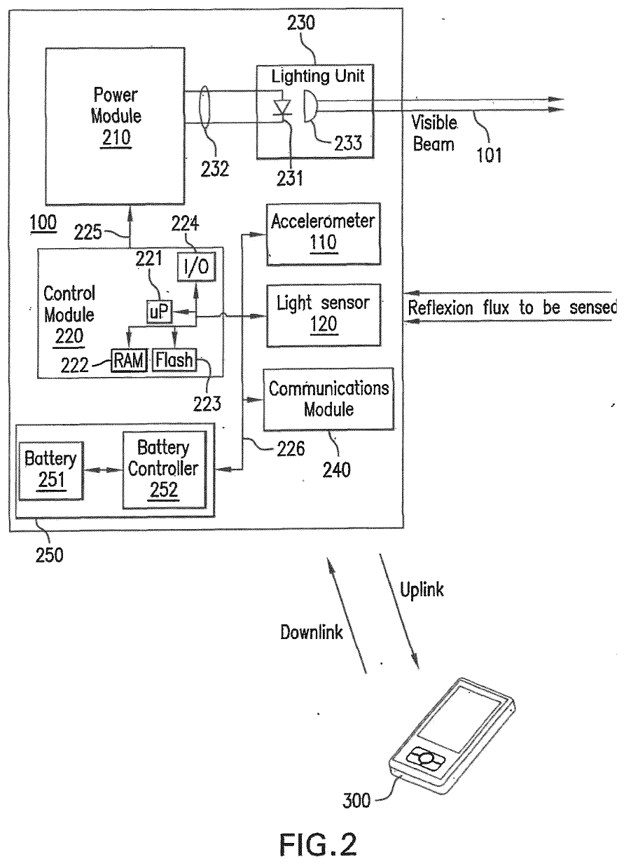

FIG. 2 illustrates the general physical architecture of an embodiment of a lamp 100—assumed to be a headlamp—comprising in a particular embodiment a reactive or dynamic light intensity regulation system based on a sensor 120 making it possible to measure the ambient luminosity and/or part of the flux reflected by the illumination of the headlamp.

The lamp 100 comprises an accelerometric sensor, and preferably a three-dimensional (3D) acceleration sensor 110 making it possible to generate accelerometric information along at least one axis and preferably three axes X1, Y1, Z1, the axes X1 and Z1 being horizontal and the axis Y1 being vertical.

More specifically, the lamp 100 comprises a power module 210 associated with a control module 220 and a lighting unit 230 comprising at least one light-emitting diode LED and, optionally, a transmitter-receiver module 240 coupled to the control module and a battery module 250 also coupled to control module 220.

In the example of FIG. 2, the lighting unit 230 comprises a single LED diode 231 equipped with its power supply circuit 232 connected to the power module 210. Clearly, several diodes could be envisaged for obtaining a beam of strong light. In general, the LED diode(s) can be associated with its own focal optics 233 making it possible to ensure collimation of the generated light beam.

In a specific embodiment, diode LED 231 is powered by power module 210 via circuit 232, under the control of a control information or a control signal generated by the control module 220 via a link which may take the form of a control wire or, alternatively, a set of wires forming a control bus. The figure shows more specifically the particular example of a control lead 225.

The power module 210 specifically comprises all the components that are conventionally included in an LED lighting lamp for the production of a high intensity light beam, and in general based on Pulse Width Modulation (PWM), well known to a person skilled in the art and similar to that encountered in class D audio circuits. This PWM modulation is controlled by means of the control signal 225 generated by the control module 220. In general, it will be noted that the term “signal” mentioned above refers to an electrical quantity-current or voltage-making it possible to cause the control of the power module, and in particular the PWM modulation used to supply the LED diode 231 with current. This is only a particular embodiment, it being understood that it will be possible to substitute for the “control signal 225” any “control information”, for example a logic information stored within a register and as mentioned above, transmitted to power module 210 by any suitable means so as to control the power of the light beam. The control signal can therefore be transmitted via different means depending on whether it is a control signal or a control information. These means may include a bus-type communication line coupling the control module and the power module or a simple electronic circuit for transferring a control voltage or current. In a particular embodiment, it will even be possible to envisage the two control and power modules being integrated into the same module or integrated circuit.

A person skilled in the art will therefore easily understand that when one refers to a “control signal 225”, one encompasses indiscriminately the realizations using an electrical control quantity—current or voltage—as well as the realizations in which the control is carried out by means of logic information transmitted within the power circuit. For this reason, reference will be made hereinafter indistinctly to a control signal or a control information.

In general, the components being included into power module 210—switches and circuits—are well known to a person skilled in the art and the description will be deliberately lightened in this respect for the sake of conciseness. Similarly, the reader will be referred to general works dealing with the various aspects of PWM modulation.

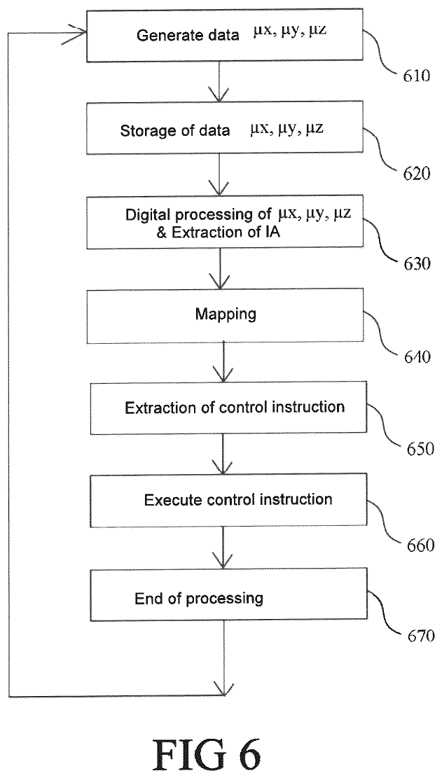

Returning to FIG. 2, it can be seen that the control module 220 comprises a processor 221 as well as volatile memories 222 of the RAM type and non-volatile memories 223 (flash, EEPROM) as well as one or more input/output circuits 224. RAM memory and non-volatile memories are for storing data and firmware or firmware instructions. In one particular embodiment, as described in European patent application EP21164886.0 incorporated in the present application by simple reference, the non-volatile memory 223 is also used to store data representative of physical activity profiles which will be used in conjunction with the accelerometer data provided by the accelerometric sensor 110. Furthermore, non-volatile memory 223 will also be used for storing a mapping table which will be described below in relation to FIG. 6.

The headlamp also comprises a battery module 250 having a controller 252 and a battery 251 for example of the Ion-Lithium type.

In general, control module 220 can access each of the other modules present in the lamp, and in particular the power module 210, the battery module 250, the two sensors-light sensor 120 and accelerometer sensor 110—as well as, if applicable, to the communication module 240 allowing two-way (uplink and downlink) wireless communication with a smartphone 300 or any other wireless communication device.

Preferably, the control module will integrate specific micro-software into its internal memory allowing the implementation of the processes described below, with the aim of creating a new, particularly efficient user interface which, moreover, will be programmable.

The access of the control module 220 to the different components of the headlamp may take various forms, either by means of specific circuits and/or wires or a set of wires forming a bus.

By accessing the different modules making up the headlamp, the control module 220 can both read and collect information contained in each of these modules and/or conversely, transfer information, data and/or commands thereto, and more generally implement the different steps of the process of a user interface which will be described hereinafter more precisely.

This is how the control module 220 can forward to the power module 210 a control signal as represented by the signal transmitted on control lead 225 and, more generally, can read the current value of the supply current of the diode 231 transiting via conductors 232 (via circuits and/or buses not shown in the figure).

Similarly, control module 220 can access the battery module 250 via the bus 226 to read there either the different voltage values (depending on the charge or discharge cycle being in progress) at the terminals thereof and/or the value the intensity delivered in order to be able to calculate a State of Charge (SOC).

### II. Communication Module 240

The control module 220 comprises a communication module 240 allowing a two-way wireless link with a mobile information processing system or mobile telephone 300. In a preferred embodiment, the transmitter as well as the receiver will be compatible with the Bluetooth standard, preferably with the Bluetooth 4.0 Low energy standard. In another embodiment, the WIFI or IEEE802.11 standard will be adopted instead or any other available standard for a wireless communication. The module 240 comprises a baseband unit (not shown) coupled to a wireless receiver and wireless transmitter, making it possible to arrange an uplink communication channel to the mobile telephone 300 and, conversely, a downlink communication channel from this same phone. To this end, the communication module 240 may be required to perform various processing operations, in series or in parallel, on the digital representation of the data signal being received and transmitted, and in particular, operations of filtering, statistical calculation, demodulation, channel coding/decoding making it possible to make the communication robust to noise, etc. Such operations are well known in the field of signal processing, in particular when it is a question of isolating a particular component of a signal, likely to carry digital information, and it will not be necessary here to weigh down the presentation of the description.

Once detected, these packets are forwarded to processor 221 within control module 220.

The processor 221 is therefore responsible for interpreting the received packets as well as formatting the packets to be transmitted according to a format specific to the standard used. Thus, in the case of the Bluetooth Low Energy standard, these packets will have a structure around the standardized Generic Attribute Profile (GATT) that we will not detail here. Depending on the interpretation of the data bits included in the packets received, the processor will reconstruct any information or commands received on the downlink from the mobile information processing system 300. Having interpreted this information or commands, the processor 221 will then relay or convert this information or command to the module concerned. Thus, in the basic embodiment, the processor 221 identifies commands to the attention of the power module 210 in order to modify the light intensity and in reaction to this identification is capable of generating control information conveyed on control lead 225 to destination of the power module 210 so that the latter proceeds to modify the light intensity generated by the lighting unit 230.

In addition, processor 221 is also configured to identify read requests from associated mobile information processing system 300 in order for the headlamp to forward via the uplink certain parameters or data to telephone 300.

These requests can thus be a request for the state of charge of the battery or the value of the current light power. In this case, the processor 221 will retrieve the necessary information directly from the module concerned and after having carried out any additional calculations on this information to obtain the final required information (in the case of the state of charge for example as evoked above), will format a corresponding data packet for transmission by transceiver module 240.

It is clear that FIG. 2 describes a preferred embodiment, and that many other embodiments are possible and within the scope of a person skilled in the art. For example, in a more sophisticated mode, other modules can be added within the headlamp and these modules will also be coupled to processor 221 via bus 226 for example. These modules can then also exchange uplink or downlink data or commands with the associated mobile information processing system 300 which can then communicate with the headlamp and transmit various configuration commands to it by means of a dedicated application running within the smartphone. This dedicated application then makes it possible to coordinate the various functionalities of the headlamp by notably offering a user-friendly interface by means of which the latter can either enter operating parameters or come directly to control the headlamp or select different options to the features offered.

In a preferred embodiment, the headlamp is configured to communicate with the smartphone to initiate a learning session during which the user can record a combination of finger taps on the headlamp and associate this combination with one or more control instructions to be stored within a mapping table stored within non-volatile memory 223.

This will then result in a new user interface option that will for instance advantageously enrich and improve the dynamic control mechanism of the headlamp.

### III. Controlling the Dynamic or Reactive Lighting

One should recall that, in a preferred embodiment, control module 220 of headlamp 100 implements a dynamic or reactive lighting technique. This technique consists of replacing the well-known manual adjustment modes-based on various pre-adjusted light power values such as low, medium or high, with a more automatic technique making it possible to leave the adjustment of the light power to the control module 220 and more specifically to a regulation algorithm executed by the processor 221 under the control of a regulation firmware stored in non-volatile memory 223.

According to the principle of dynamic or reactive lighting, the processor 221 adjusts the light power according to the value of the ambient luminosity measured by the sensor 120, for example by selecting a value chosen from a set of N predefined threshold values. Such a regulation mechanism is therefore similar to an adjustment mechanism by discrete steps within a finite set of power values, allowing the control module 220 to control the headlamp by passing successively from an adjustment value to another value chosen from the set of predetermined values.

With a set of three predetermined adjustment values, corresponding to three powers, for example “low”, “medium” or “high”, the reactive or dynamic brightness mechanism therefore allows automatic adjustment of the headlamp to the correct value at within the N predetermined values.

In the same way, the geometry of the light beam can be adjusted automatically by the selection, via the control module 220, of a diffusion mode chosen from a set of several predetermined modes: for example, wide, narrow, or both in same time.

Such dynamic or reactive regulation, by discrete steps, turns out to be simple and inexpensive to implement and allows automatic switching between predefined threshold values.

However, a person skilled in the art may consider a more sophisticated regulation mechanism based on a true servo-control loop integrating the value of the luminosity within a feedback loop which may or may not be linear, in order to set the power of the light beam generated by the module 230. In this respect, error correction mechanisms could be conveniently integrated within the feedback loop, in particular a proportional (P), proportional-integral (PI) correction, or even Proportional Integral Differential (PID) etc. . . . , used with suitable parameters.

Whatever the type of light regulation envisaged, by discrete steps or by means of a linear or non-linear servo-control, the regulation of the dynamic or reactive lighting could be advantageously improved by introducing an exploitation of the accelerometer data μx, μy and μz generated by the three-dimensional accelerometric sensor 110, as will now be described for the purpose of immediately and significantly increasing, upon request from the user, the light beam of the lamp.

Beyond this immediate addition of additional light, we could even, as we will see later, create a new user interface (human-machine interface).

### IV. Collaboration of the Accelerometer 110 for the Realization of a New Programmable User Interface

European patent application EP21164886.0 describes the use of the accelerometer to enable the identification of predetermined usage profiles in order to enable automatic optimal configuration of the headlamp. Thanks to the methods described in this application EP21164886.0, the control module 220 can identify, from the statistical data provided by the accelerometer, the ideal profile best corresponding to a given activity (running, walking, cycling, etc.) and apply a detailed and ideal configuration to it.

As will now be described, we now add to this optimal and automatic configuration the creation of a new user interface which exploits the data generated by the accelerometer.

Generally speaking, the three-dimensional accelerometer module 110 provides accelerometer signals μx, μy and μz along three trigonometric axes X1, Y1 and Z1 and, more specifically, X1 and Z1 axes are horizontal while the Y1 axis is a vertical axis. Moreover, X1 and Y1 axes are arranged in a sagittal plane relative to the user.

The inventors of the present patent application advantageously observed that, by analyzing the μx, μy and μz signals, the close sequences of peaks on the Y1 axis could occur frequently, while these same sequences were much rarer along the two horizontal axes X1 and Z1.

Consequently, the inventors decided to exploit this observation by integrating a new algorithm within the microprogram housed in the non-volatile memory 223 of the control module 220 for discriminating the accelerometer signals sensed along the two horizontal axes X1 and Z1 with respect to the accelerometer signal sensed along the vertical axis Y1 so as to produce relevant acceleration data even when the lamp on a user's head who is running/walking. Thanks to such discrimination between the horizontal signals μx, μz and the signal μy on the vertical axis, the algorithm will allow the detection over a predefined duration—from a few hundred milliseconds to a maximum of one second—of a sequence of at least two pulses or peaks whose amplitude exceeds a predetermined threshold on one of the two horizontal accelerometer signals μx, μz, and the use of that detection as a control element for a temporary and significant increase in the brightness of the headlamp (“increase boost”).

This detection of a double ‘peak’ or pulse in the μx signal (for example) is performed using appropriate digital processing to process, filter, and store the digital accelerometer signal μx received from the accelerometer in the headlamp.

In a particular embodiment, such digital filtering includes high pass filtering to detect rapid variations in the digital signal μx.

The detection of at least one double “peak,” or double accelerometric pulse having an amplitude exceeding a predetermined threshold level in the μx signal, will then be identified by the control module 220 as being the recognition of a “double tap” that the user of the headlamp would make by means of their fingers “tapping” the headlamp.

In a preferred embodiment, the control module uses this detection of a double peak to generate a control signal commanding a temporary and significant increase in brightness.

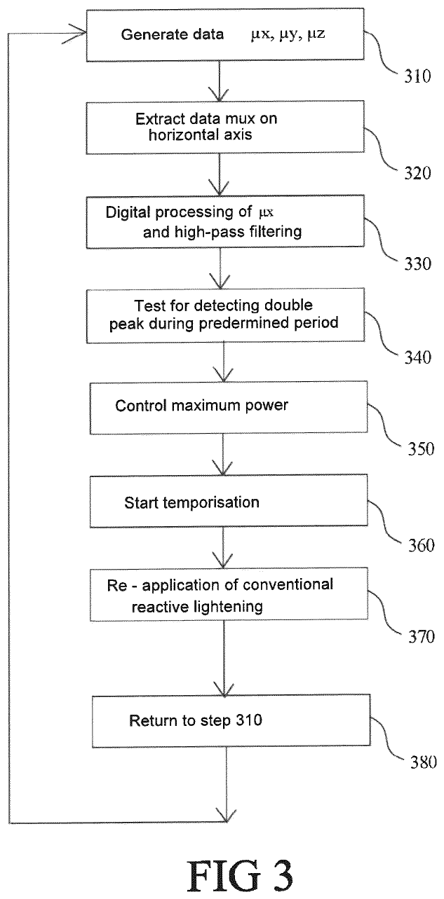

The method is illustrated more specifically in FIG. 3, which comprises a first step 310 during which the accelerometric module 110 generates accelerometric data μx, μy, and μz, which are then respectively stored in the RAM 222 of the control module 220.

In a step 320, the processor 221 more specifically extracts a digital data sequence on at least one horizontal component, for example the signal μx, and stores this specific sequence in a particular area of the RAM 222.

Then, in a step 330, the processor performs appropriate digital processing of the data sequence μx using software firmware stored in non-volatile memory 223. In particular, the digital processing includes a series of filtering operations, including high-pass filtering, to reveal rapid variations in the processed signal.

The method then proceeds with a step 340, which is a test to determine whether, during a predefined duration, the processed data sequence μx includes at least one significant double peak—with an amplitude exceeding a predetermined threshold—and which could then be interpreted as corresponding to a double “tap” made by the user's finger along the X1 axis.

If such a double peak is detected, the method then proceeds to a step 350 during which the control module 220 generates, via its processor 221, a signal or control information on the circuit 225 intended to significantly increase the illumination of the lamp (“boost” lighting). In one embodiment, the process may also modify the geometry of the light beam by, for instance, switching to a wide light beam which replaces or is being added to a narrow beam.

The method then proceeds to a step 360, which is the start of a timer allowing the increased lighting (“boost”) to last for a predetermined duration.

When the timer in step 360 expires, the method then proceeds to a step 370, in which the control module 220 switches back to a conventional lighting mode, for instance the reactive lighting mode wherein the control module 220 uses the information provided by the light sensor 120 for setting the brightness of the headlamp, possibly by taking into account the initial parameters determined by the profiles identified by the accelerometric module 110. This step 370 therefore ends the temporarily performed “boost” lighting.

Then, in a step 380, the method then loops back to the initial step 310 to perform an analysis of a new set of accelerometer data analysis and allow a new detection of a double “tap” on the horizontal μx signal sequence.

As can be seen, the method in FIG. 3 makes it possible to implement, very simply and without requiring new and costly components, a new functionality which temporarily increases the brightness of the headlamp upon request by a user who simply needs to tap the headlamp twice along the X1 axis with their finger. Because the double tap is being sensed along a horizontal axis—axis X1 for instance—the method shows less sensitive to the quite noisier acceleration data sensed along a vertical Y1 axis present when the user is walking or most of all when he is running. There is thus provided a very effective user interface functionality which may be used even when the headlamp is worn by a user who is moving, and this is a significant advantage with respect to the conventional methods.

This results in improved ergonomics and ease of use of the headlamp.

This improved ergonomics is already a first advantage of the present invention.

It will now be shown that it is possible to further improve the ergonomics of the headlamp by incorporating additional digital processing, even creating a new user interface that can even be programmable by means of a mapping table to be stored within the non-volatile memory 223 included into control module 220 of headlamp, which mapping table stores reference IAR vectors (standing for Impulse Acceleration Reference) along at least two axis to be associated with control instructions for controlling the headlamp.

Indeed, in an alternative embodiment, the detection method incorporates an algorithm for detecting a pulse sequence on at least two μx and μy signals, for example, which would correspond to a double tap performed jointly by several fingers, including the thumb and index finger, operating according to their natural morphological opposition, along several axes but at a relatively precise angle linked to this natural morphology, and which could be very advantageously stored in memory during a learning process to enable subsequent decoding of a control instruction.

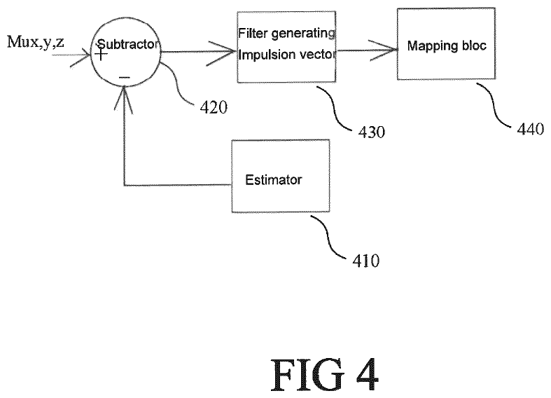

In general, the processing of μx accelerometry data may use numerous digital processing and filtering techniques well known to a person skilled in the art. Moreover, it will be possible to simultaneously process the three components as needed, as illustrated in the general architecture diagram of FIG. 4, showing a block 410 receiving in real time the signals μx, μy and μz generated by the accelerometer 110, which block 410 is responsible for generating an estimate Ex, Ey, and Ez of an acceleration vector integrating several iteration sequences so as to construct an accelerometer vector representative of the movement induced by the user's walking or running.

This block 410 is used in a feedback loop by means of a subtractor block 420 which subtracts the result of the estimation Ex, Ey, and Ez performed by block 410 from the accelerometer vectors μx, μy, and μz generated in real time by the accelerometer 110 in order to generate a relative acceleration vector μ′x, μ′y, and μ′z which more specifically concentrates the rapid variations in the accelerometer pulses originating in particular from the user's fingers.

A filtering block 430 processes the relative acceleration vector μ′x, μ′y, and μ′z to generate a pulse vector Ix, Iy, and Iz, which will be presumed to be representative of the rapid tapping of the fingers and can then be transmitted to a mapping block 440.

The mapping block 440 then maps the pulse vectors Ix, Iy, and Iz to a pattern represented by a IAR vector that has been previously stored in a mapping table located within the non-volatile memory of the headlamp during a learning phase. This previously stored pattern will correspond to a finger movement previously defined by the user during the learning phase and associated with a predetermined control instruction.

The result of the mapping then allows the command block 220 to extract the corresponding control instruction and, subsequently, to automatically execute that instruction.

The operations of filtering and digital processing of accelerometry data may use several variants or digital filtering techniques which will not be detailed further in order not to make the presentation cumbersome. It will also be possible to advantageously implement techniques based on artificial intelligence to refine the construction of the estimated vector Ex, Ey, and Ez, and to discriminate the specific contributions to the specific tapping provided by the tapping pattern emanating from the thumb/index finger pair according to their natural morphological opposition.

Concretely, by reproducing such a specific tapping pattern using the thumb/index finger pair, the control module will be able to decode the corresponding accelerometer data and extract the corresponding command code stored in memory during the learning phase described above.

In this way, the headlamp can be conveniently controlled even while the user is walking or running.

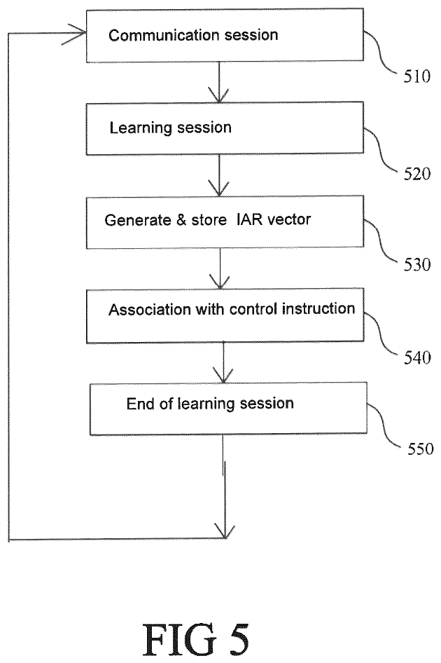

FIG. 5 more specifically illustrates a method for learning a control instruction to be associated with a corresponding IAR vector stored within the mapping table stored in the non-volatile memory 223 of the headlamp based on processing, analysis, and detection of a sequence of pulses or peaks in the accelerometer signals μ, μ, and μz.

The method begins with a step 510 during which the headlamp enters into a communication session with a smartphone.

Then, in a step 520, the method enters a learning phase operating without movement of the headlamp. In this learning phase, the control module 220 analyzes and processes the accelerometer data μx, μy and μz received in real time from the accelerometer 110 while the user performs a reference tap using one or more fingers, and preferably the thumb/index finger pair having a natural morphological opposition which will result in a particular correlation on the accelerometer signals μx, μy and μz. In addition, temporal data corresponding to the user's tapping frequency will also be analyzed and processed during the learning phase.

In a step 530, the control module 220 generates a reference accelerometric pulse vector Ix, Iy, Iz IARx,y,z corresponding to this learning, which is then entered into a mapping table stored in non-volatile memory 223 of the headlamp.

Then, in a step 540, the method associates the vector IARx,y,z with a control instruction predefined by the user, which could be, for example, an immediate increase in brightness, or even a turning off the lamp, etc. Such control instruction is also stored within the mapping table stored in the non-volatile memory 223 of the headlamp.

The learning phase then ends with a step 550, and the communication session with the smartphone ends.

Outside of the learning mode and in headlamp usage mode, the control module analyzes in real time the accelerometer data μx, μy, and μz received from the accelerometer sensor and performs an ad hoc digital processing and filtering to extract an accelerometer vector corresponding to a specific combination of thumb/index finger taps, if applicable, to be finally mapped to a reference accelerometer pulse vector IARx,y,z stored in the non-volatile memory of the headlamp. Once a mapping is found to be successful, the control module extracts the corresponding control instruction from the mapping table and executes it.

FIG. 6 illustrates the control method more specifically, which begins with a step 610, during which the accelerometer module generates accelerometer data μx, μy, and μz.

Then, in a step 620, the processor 221 stores this data within the RAM 222.

Next, in a step 630, the processor performs appropriate digital processing of these μx, μy, and μz data, including one or more digital filtering operations, to extract therefrom an accelerometric pulse vector IAx,y,z that could correspond to a specific combination of a thumb/index finger tapping movement.

The method then proceeds with a step 640, which maps this accelerometric pulse vector IAx,y,z extracted in step 630 to a reference accelerometric vector IARx,y,z stored in the memory 223 of the headlamp, and which corresponds to a predetermined combination of thumb/index finger taps on the headlamp. To this end the current vector IAx,y,z is compared to the set of reference vectors IARx,y,z which are stored within the mapping table so as to identify one possible candidate of a IARx,y,z vector matching the thumb/index finger tapping movement performed by the user of the headlamp.

Then, in a step 650, when the mapping succeeds et lead to the identification of a reference vector IARx,y,z, the control module 220 extracts the control instruction associated with the reference acceleration vector IARx,y,z stored in the memory, and in a step 660, the command is executed automatically.

Then, in a step 670, the method returns to step 610 for the potential decoding of a new command.

The method of FIG. 6 therefore enhances the method already described in FIG. 3 by the simultaneous and joint exploitation of all the accelerometer signals μx, μy, and μz generated by the accelerometer 110, and the mapping of these same signals and the peaks they comprise with a vector IARx,y,z corresponding to a predefined command stored in the mapping table of non-volatile memory of the headlamp.

It is clear that, depending on the computing power available within the processor 221, the most efficient algorithms, in particular based on artificial intelligence, could be envisaged so as to allow the discrimination of double or triple taps made by the fingers of a user on the headlamp compared to the accelerometer signals caused by the movement of the user (walking, running, cycling, etc.) which will be considered and managed as “noise” compared to the more rapidly tapping signals which will have to be detected, extracted and decoded to execute the corresponding command.

### V. Particular Embodiment: Improved Human Machine Interface (HMI) for the Management of the Battery Life

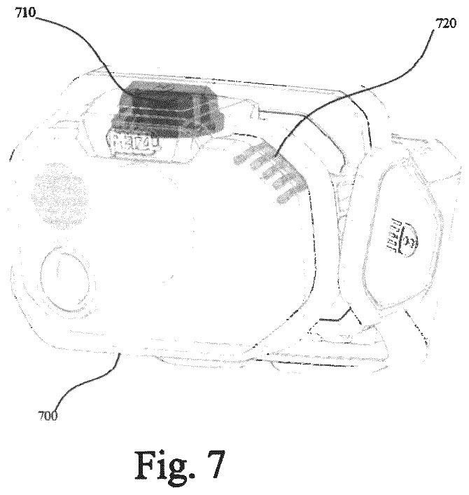

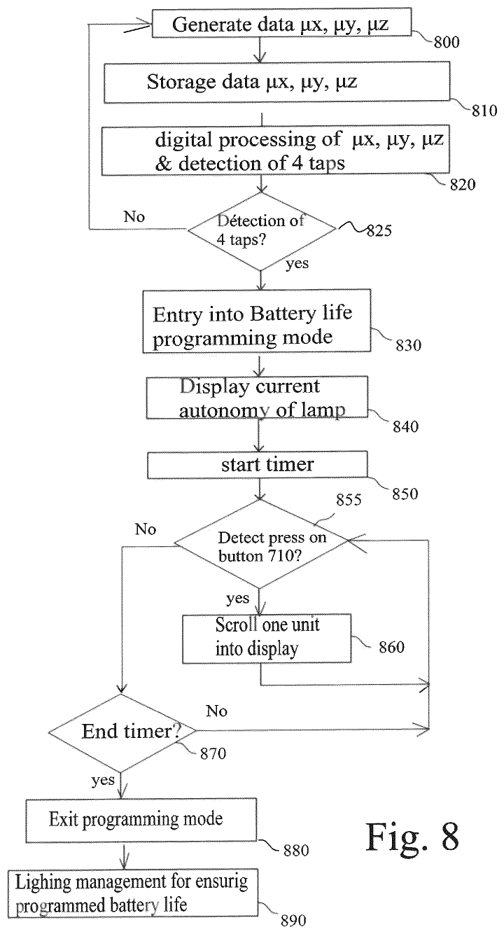

It will now be described, in relation to FIGS. 7 and 8, how the functionalities can be integrated to create a headlamp with two characteristics that are difficult to combine, namely:
A highly simplified structure and therefore economical to manufacture;
A particularly sophisticated user interface (HMI).

As shown in FIG. 7, the headlamp is presented in the form of a simplified housing 700 comprising only a single control button, for example, a BP 710 push button used for switching on/off the headlamp, associated with an LED segment display 720, for example, a five-segment display configured to offer a unique dual functionality.

The LED segment display 720 is controlled by the control module 220 described above and is configured to offer two functionalities.

A first function of the display 720 is that of a classic visual thermometer, allowing direct viewing of the battery status, according to five charge levels. This visualization could occur, for example, when detecting a brief press on the push button (a long press being associated with a switch-off of the headlamp).

A second function is that of an HMI user interface cooperating with a novel mode for programming the battery life as desired by the user. To this end, the control module included in the lamp is configured to:
perform digital processing of said captured accelerometer data in order to detect a set of N>2 consecutive taps and, following said detection, enter a battery life programming mode; and
in this programming mode, perform a circular scrolling of the display of said LED segments, each of said LED segments corresponding to a programming of one battery life unit, preferably one hour per LED segment displayed.

The method is illustrated more specifically in FIG. 8, where it can be seen that it starts with a step 800, during which the accelerometric module generates accelerometric data μx, μy, and μz as previously in FIG. 6.

Then, in a step 810, the processor 221 stores this data in the RAM 222 accessible to the headlamp's microprocessor.

Then, in a step 820, the processor performs appropriate digital processing of this data μx, μy, and μz, including one or more digital filtering operations as described previously, so as to detect a set of four consecutive taps on the headlamp, along a particular x, y, or z axis.

A step 825 is a test for determining whether a sequence of four taps has been detected or not.

In the case where such sequence is not detected, the process proceeds back to step 800 for a new generation of acceleration data.

On the contrary, in the case of detection of a sequence of four taps, the process proceeds with a step 830, which is an entry into a programming mode of the autonomy of the battery.

Then, in a step 840, the process proceeds to the display of the current programming of the remaining autonomy on display 720. For a programmed autonomy of a unit of time, for example one hour, the display 720 will only light up one single LED. For a programmed autonomy of two hours, the display 720 will light up two LEDs corresponding to this autonomy and so on. A maximum autonomy of five hours will cause all five LEDs to be displayed on the segment display 720 etc. An additional press on the push button would then have the effect of returning to a minimum value of an autonomy programming.

Then, the process proceeds with a step 850, which is the start of a predetermined time delay or timer.

Then a new test is determined, in a step 855, so as to detect a press on the push button 710 of the headlamp.

If such a press is detected, then the process proceeds with a step 860, wherein the programming of the remaining autonomy—presumably wished by the user and to be displayed during step 840—is being changed by one unit. This means that if display 720 displays two LEDs on—which is representative of a current programmed autonomy of two hours-step 860 will result in the display of a third LED on display 720 so as to confirm the user that the Battery life management will try to make it last at least three hours and no longer two hours as previously programmed.

Preferably, when the current display of display 720 is set on a displaying of five LEDs, the progress of step 860 will lead to a return to a display with only one LED displayed, which is representative of a management of an autonomy set at only one hour.

After progressing through step 860, the method returns to step 855 to detect a possible new press on button 710.

On the other hand, if step 855 had led to the determination that no press had been detected on push button 710, the method proceeds from step 855 to step 870, which corresponds to a test determining the completion of the time delay started in step 850.

If the timer is not expired, the process then proceeds back to step 855 in order to continue the possible detection of a press on push button.

However, if the timer expires, the method proceeds from step 870 to step 880, which corresponds to an exit from the programming mode. Alternatively, the process may also exit the programming mode by means of a detection of a new set of N>2 consecutive taps.

The method then continues with step 890, which corresponds to the application of a newly defined battery life management system, so as to ensure a headlamp illumination time corresponding to the number of hours selected by the user during steps 855-860 of the method.

As can be seen, the headlamp and its microprocessor are configured to allow the user to program the desired battery life in an extremely intuitive and cost-effective manner, utilizing the cooperation between a single push button, an n-segment display (preferably n=5), and an accelerometer providing accelerometric data.

Of course, the method just described in relation to FIG. 8 can be advantageously combined with the method in FIG. 3 to offer, without additional manufacturing costs, a “Boost-Tap” functionality providing a temporary increase in illumination by simply tapping the headlamp.

Clearly, it will be possible to make more sophisticated the Machine User Interface by means of the programming of patterns of accelerometric impulses, along different axis and time defined, so as to control this or that new functionality of the headlamp.

What is claimed is:

1. A headlamp comprising (700) comprising:
a light source;
a power on/off push button (710) for switching on/off the headlamp;
a power module for generating a current supply for said light source;
an M-segment display (720) for displaying the battery charge status;
a control module for adjusting the light intensity generated by said light source; and
an accelerometer configured to provide, at regular intervals, data representing an acceleration of the headlamp along at least one horizontal axis X1 and one vertical axis Y1;
wherein said control module is configured to store and digitally process the data representative of said acceleration;
characterized in that the control module is further configured:
to perform digital processing of said captured accelerometer data in order to detect a set of N>2 consecutive taps and, following said detection, to enter a battery life programming mode; and
in said programming mode, following each new action on said push button, to perform a circular scrolling of the display of said LED segments, each of said LED segments corresponding to a programming of one battery life unit.

2. The headlamp according to claim 1, wherein the exit from the programming mode is performed after a predetermined duration.

3. The headlamp according to claim 1, wherein the exit from the programming mode is performed by detecting a new set of N>2 consecutive taps.

4. The headlamp according to claim 1, wherein M=5 and N=4, and wherein said unit of battery life is the hour.

5. The headlamp according to claim 1, wherein the control module is further configured to perform digital processing of said accelerometer data captured along at least one horizontal axis, said digital processing comprising high-pass filtering in order to detect a double peak occurring within a predefined time period;
wherein the detection of a double peak occurring within a predefined time period triggers a temporary increase, for a predefined duration, in the brightness of the headlamp.

6. The headlamp according to claim 1, further comprising a light sensor for capturing light from the environment of the wearer of the lamp and in which the control module is configured to control the brightness of the light source according to the information generated by the light sensor.

7. A method for controlling a headlamp as defined in claim 1, comprising the steps of:
generating (800) by means of an accelerometer accelerometric data along one or more axes μ, μ y and μz;
storing (810) said accelerometric data in a storage memory;
processing (820) said accelerometric data so as to detect a set of N>2 consecutive taps on the lamp;
in the event of detection of this said sequence of four taps, entering (830) a mode for programming a battery life of a battery of said lamp;
displaying (840) the current value of the programming of said battery life on an M-segment display, each segment displayed corresponding to a unit of battery life time;
starting (850) a predetermined time delay;
detecting (860) one or more presses on said headlamp push button and, in response to said detection, modifying the display of said display to add a time unit to the current programming for each press and, when the current value is already the maximum value, to return to a minimum value of a battery life programming;
testing (870) the end of the time delay; and
exiting (880) the programming mode and applying the new current value of the newly programmed battery life duration.

8. The method of claim 7, wherein M=5 and N=4 and wherein said battery life unit is the hour.

9. The method according to claim 7 characterized in that it further comprises the following steps of:
generating (310) at regular intervals a set of accelerometer data μx, μy and μz provided by said accelerometer;
extracting (320) said data along at least one horizontal axis μx or μz and storing said data in a random-access memory (222);
performing digital processing (330) on said stored data μx, μz including in particular high-pass filtering in order to detect a sequence of two pulses or peaks during a predetermined duration;
in response to said detection, generating by said control circuit a control signal intended to increase the light power of the lamp;
starting a time delay (360) so as to limit in time the duration of increase of the light power;
re-establishing the light regulation method (370) after the expiration of said timer; and
looping back to the first step to process new accelerometer data.

10. A method according to claim 9, wherein said digital processing (330) is used to map the accelerometer signals to a specific control instruction intended to modify the operation of the headlamp.

11. A method according to claim 7, wherein the headlamp communicates with a mobile phone for the purpose of configuring the headlamp, and wherein the communication with the mobile phone enables the headlamp to be trained to associate double- or triple-peak detection patterns in the accelerometer signals μx, μy, and μz with specific finger movements of a user tapping the headlamp.

12. A method according to claim 11, wherein the communication session with a mobile telephone comprises:
a learning mode operating without movement of the headlamp, in which the user taps the headlamp using the index finger and thumb, together, and this tapping is analyzed, processed, and filtered by the control unit so as to generate a reference accelerometric pulse vector that is stored in memory;
Wherein the reference accelerometric pulse vector is associated with a specific operating command for the headlamp.

13. A method according to claim 11 wherein, outside the learning mode and during use of the headlamp, the control module analyzes the accelerometric data μx, μy and μz by means of digital filtering so as to extract therefrom an accelerometric vector capable of being mapped with a specific movement of the index/thumb pair corresponding to a specific command stored in memory in order to execute a corresponding command extracted from the memory.
